(19) United States
(12) Patent Application Publication
(10) Pub. No.: US 2026/0140249 A1
(43) Pub. Date: May 21, 2026

(54) CONCURRENT MULTI-BAND AND/OR MULTI-MODE WIRELESS LOCAL AREA NETWORK (WLAN) SENSING

(71) Applicant: Cypress Semiconductor Corporation, San Jose, CA (US)

(72) Inventor: Kameswara Medapalli, Saratoga, CA (US)

(73) Assignee: Cypress Semiconductor Corporation, San Jose, CA (US)

(21) Appl. No.: 19/223,253

(22) Filed: May 30, 2025

Related U.S. Application Data
(60) Provisional application No. 63/721,284, filed on Nov. 15, 2024.

(51) Int. Cl. G01S 13/62; H04W 4/38; H04W 84/12

(52) U.S. Cl. CPC G01S 13/62; H04W 4/38; H04W 84/12

(57) ABSTRACT

A method includes causing, by a processor of a client wireless device, a first transceiver and a second transceiver to time-multiplex switch, while operating in a Wi-Fi® radar mode, between a first wireless band and a second wireless band. The method includes retrieving first channel state information (CSI) data from first reflected wireless signals received by the second transceiver after transmitting, by the first transceiver, wireless signals in the first wireless band and retrieving second CSI data from second reflected wireless signals received by the second transceiver after transmitting, by the first receiver, wireless signals in the second wireless band. The method includes processing, by the processor, the first and second CSI data to perform wireless local area network (WLAN) sensing in an environment of the client wireless device.

### REFERENCE TO RELATED APPLICATION

This application claims the benefit of U.S. Provisional Ser. No. 63/721,284, filed Nov. 15, 2024, the entirety of which is incorporated herein by reference.

### TECHNICAL FIELD

This disclosure relates to client wireless devices and, more specifically, to concurrent multi-band and/or multi-mode WLAN sensing.

### BACKGROUND

Many applications are being developed to run on client wireless devices such as on mobile devices (e.g., smart phones, wearables), in home automation devices, and other Internet of Things (IoT) devices where sensing capability is desired. This sensing capability generally relies on regular Wi-Fi® or other wireless sensing using channel state information (CSI) data retrieved from CSI packets interspersed within normal wireless signals being exchanged during standard wireless communication. This wireless or Wi-Fi® CSI sensing, however, is not very accurate and has limited range. While wireless/Wi-Fi® radar sensing is more accurate and has better range, Wi-Fi® radar sensing is more complex to implement (e.g., transmission is required) and consumes more power, which can limit use of wireless radar sensing.

### BRIEF DESCRIPTION OF THE DRAWINGS

FIG. 1 is a simplified block diagram of a wireless network in which an example client wireless device operates within an environment to be sensed according to various embodiments.

FIG. 2 is a schematic block diagram of a client wireless device configured to perform radar sensing according to some embodiments.

FIG. 3 is a flow chart of a method for performing concurrent multi-band sensing by a client wireless device in a regular wireless mode according to some embodiments.

FIG. 4 is a flow chart of a method for performing concurrent multi-band sensing by the client wireless device in a wireless radar mode such as a Wi-Fi® radar mode according to some embodiments.

FIG. 5A is a flow chart of a method for performing concurrent multi-band and multi-mode sensing that employs both regular wireless mode and wireless radar mode according to some embodiments.

FIG. 5B is a flow chart of a method for performing the radar sensing in the Wi-Fi® radar mode also in multiple bands according to some embodiments.

### DETAILED DESCRIPTION

The following description sets forth numerous specific details such as examples of specific systems, devices, components, methods, and so forth, in order to provide a good understanding of various embodiments of multi-band and/or multi-mode WLAN sensing. For example, CSI packets can be gathered out of the air from numerous wireless devices and which contain CSI data that characterizes the properties of a wireless communication channel. These CSI-based properties, when characterized, can be employed to sense objects or motion such as detecting the presence or movement of an animal, person, or a car.

In particular, CSI data captures path loss, or the reduction in power density of a signal as it propagates through space. Further, CSI data captures fading, or variations in the amplitude of a signal at a receiver due to changes in the transmission medium or path. Additionally, CSI data captures time delay, e.g., delays incurred by the signal as it travels through different paths from the transmitter to the receiver. Also, CSI data captures phase shift, or changes in the phase of the signal as it encounters different propagation environments. By detecting this CSI-based channel characterization, a client wireless device can perform wireless or Wi-Fi® sensing within its environment, e.g., to detect the presence or movement of an object, including localization.

As was discussed, however, wireless CSI sensing (such as Wi-Fi® sensing) is not very accurate, has a short range, and cannot be performed all the time due to concerns of power consumption by client wireless devices, some of which operate in low power. Further, wireless CSI sensing typically operates over a single frequency band and is thus of limited bandwidth, leading to some of the accuracy challenges. Accordingly, wireless radar sensing (such as Wi-Fi® radar sensing) can instead be employed in some client devices to improve sensing accuracy and range. As was discussed, however, wireless radar sensing can be more complex and consume more power to implement. Further, wireless radar sensing is also typically performed in a single frequency band, which is thus also of limited bandwidth and still limited accuracy and resolution that depends on the frequency band.

To resolve deficiencies with known approaches to wireless/Wi-Fi® CSI-based and wireless (or Wi-Fi®) radar sensing, according to disclosed embodiments, the present disclosure sets forth methods, generally to be implemented by a client wireless device, in which the client wireless device time-multiplexes during sensing between multiple frequency bands (e.g., 2.4 gigahertz (GHz), 5.0 GHz, and 6.0 GHz) and/or between different sensing modes, namely between communicating in a regular wireless mode and operating in a wireless radar mode. Further, the client wireless device can also scan within sub-band ranges (e.g., different channels) within each frequency band and then combine these different sub-band scannings to effectively increase the bandwidth over which the sensing can occur in each frequency band. While performing scanning in the wireless radar mode in different frequency bands in a time-multiplexed manner may involve time synchronization of transmission and reception of wireless radar signals in each band, the increased CSI data obtained from such multi-band scanning can significantly improve sensing and ranging capabilities.

In particular, in least one embodiment, the client wireless device causes a transceiver to time-multiplex switch between communicating in a first wireless band and in a second wireless band. The client wireless device retrieves CSI data from the wireless signals received by the first transceiver when communicating in the first wireless band and second CSI data from the wireless signals received by the first transceiver when communicating in the second wireless band. The client wireless device can then process the first and second CSI data to perform WLAN sensing in an environment of the client wireless device. In embodiments, the client wireless device causes an action to be performed by an application of the client wireless device in response to detecting at least one of presence, motion, or gestures of an object within a threshold value based on the WLAN sensing.

In at least another embodiment, the client wireless device causes a first transceiver (e.g., which transmit wireless signals) and a second transceiver (e.g., that receives wireless signals) to time-multiplex switch, while operating in a wireless radar mode, between a first wireless band and a second wireless band. The client wireless device can retrieve first CSI data from first reflected wireless signals received by the second transceiver after transmitting, by the first transceiver, wireless signals in the first wireless band. The client wireless device can retrieve second CSI data from second reflected wireless signals received by the second transceiver after transmitting, by the first receiver, wireless signals in the second wireless band. The client wireless device can then process the first and second CSI data to perform WLAN sensing in an environment of the client wireless device. In embodiments, the client wireless device causes an action to be performed by an application of the client wireless device in response to detecting at least one of presence, motion, or gestures of a person within a threshold value based on the WLAN sensing.

In additional embodiments, the client wireless device includes a first transceiver to transmit wireless signals over a first antenna, a second transceiver to receive wireless signals over a second antenna, and a processor coupled to the first transceiver and the second transceiver. In such embodiments, the processor causes the first transceiver and the second transceiver to time-multiplex switch between communicating in a regular wireless mode (or regular Wi-Fi® mode) and operating in a wireless radar mode (or Wi-Fi® radar mode). When communicating in the regular wireless mode in a first wireless band, the processor retrieves first CSI data from the wireless signals received by the second transceiver. When operating in the wireless radar mode, the processor retrieves second CSI data from reflected wireless signals received by the second transceiver, where the reflected wireless signals are reflected versions of the wireless signals transmitted by the first transceiver in a second wireless band. The processor process the first and second CSI data to perform WLAN sensing in an environment of the client wireless device.

The present disclosure includes a number of advantages, including increasing the quality and quantity of CSI data obtained from the environment of the client wireless device useable to perform WLAN sensing. The additional data is expected to help improve the sensing capability of the client wireless devices using largely the existing hardware, but switching between frequency bands and/or sensing modes while performing the WLAN sensing. The increased capability, for example, can include determining the difference between a person and a metallic object, determining the size of the person (e.g., distinguishing person from pet), and having richer data from which artificial intelligence (AI) such as machine learning can be better leveraged to provide additional sensing and localization. Such sensing is expected to help better execute applications on client wireless devices related to home automation, home safety devices, environmental controls such as thermostats, home appliances, and the like. Additional advantages will be apparent to those skilled in the art of wireless sensing and are discussed further below.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment of the invention. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

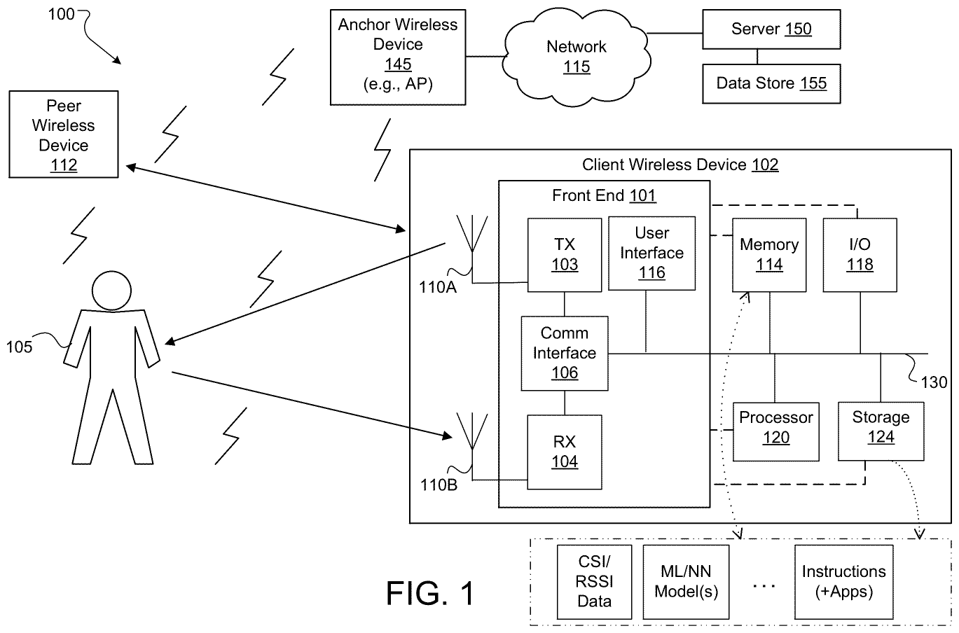

FIG. 1 is a simplified block diagram of a wireless network 100 in which an example client wireless device 102 operates within an environment to be sensed according to various embodiments. The wireless network 100 can also include at least one peer wireless device 112, for example, another client wireless device in the environment that also includes an object 105, which can include an animal, a person, a drone, a car, or other objects. In at least some embodiments, the wireless network 100 includes an anchor wireless device 145, which is not necessary for implementation of the disclosed embodiments, but which still may aid in causing wireless signals to be more prevalent in the environment from which CSI data can be derived. The anchor wireless device 145 may operate to provide access to the Internet over a network 115, and which may provide connectivity to a cloud server 150 and/or a cloud data store 155. In embodiments, the anchor wireless device 145 is an access point (AP) device, a wireless router, a wireless mesh node, a wireless gateway, a cellular base station or tower, an IoT hub or gateway, or the like.

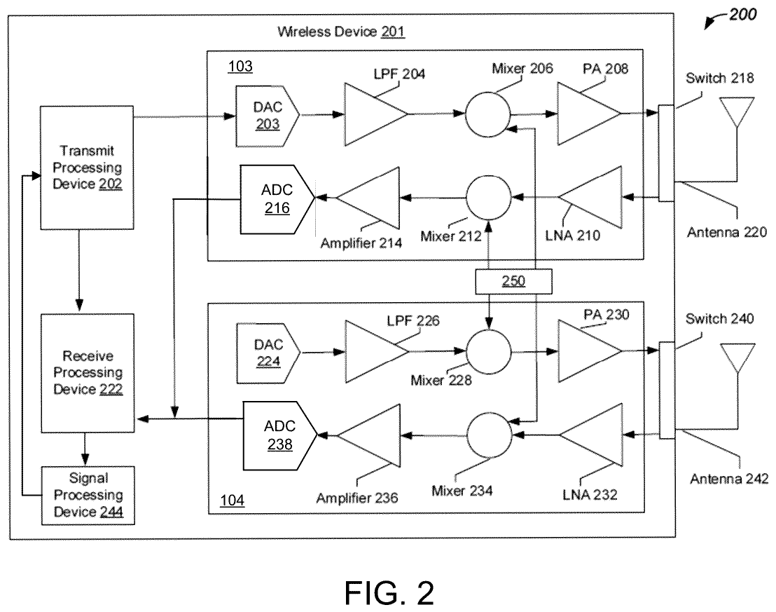

In at least some embodiments, the client wireless device 102 includes, but is not limited to, a front end 101 having a first transceiver 103, which can be configured as a transmitter (TX) and second transceiver 104, which can be configured as a receiver (RX), a communications interface 106, and a user interface 116. The client wireless device 102 may further include at least one TX antenna 110A coupled to the first transceiver 103, and at least one RX antenna 110B coupled to the second transceiver 104. In some embodiments, at least the first transceiver 103 and the second transceiver 104 a separate wireless or WLAN radios that are both present in the front end 101. In some embodiments, the front end 101 includes switching circuitry to switch between dual bands, including for example, between the 2.4 GHz, 5 GHz, and 6 GHz bands, as is discussed in more detail with reference to FIG. 2.

The client wireless device 102 may further include a memory 114, one or more input/output (I/O) devices 118 (such as a display screen, a touch screen, a keypad, and the like), a processor 120 (or processing device), and a storage device 124. These components can all be coupled to a communications bus 130 or multiple communication buses. In some embodiments, at least some of the components of the client wireless device 102 are directly connected and may thus not be coupled through the communication bus 130, which is illustrated by the dashed lines. Thus, illustration of the communication bus 130 is not be taken as required or limiting for at least some of the components of the client wireless device 102, which may directly intercommunicate. In some embodiments, aspects of the communication interface 106 work with the processor 120 to perform operations or that function as a processing device of the client wireless device 102. In some embodiments, there is a single antenna and multiplexing logic to switch use of the antenna between the first transceiver 103 and the second transceiver 104.

In at least some embodiments, the memory 114 and/or the storage device 124 include computer storage to store instructions that, when executed by the processor, cause the processor 120 to perform operations discussed herein in addition to, for example, specific operators for applications or programs executed by the client wireless device 102. The memory 114 and/or storage device 124 can also store data generated or accessed by the communication interface 106 or generated by the processor 120. The processor 120 can use the storage device 124 during execution of program code, which can be stored in the memory 114 that may or may not be the same memory components, depending on application and implementation. In various embodiments, frontend components such as the first transceiver 103, the second transceiver 104, the communication interface 106, and one or more antennas are adapted with or configured for WLAN and WLAN-based frequency bands, e.g., Wi-Fi®, Bluetooth® (BT), Bluetooth® Low Energy (LBE), Ultra-Wideband (UWB), Z-wave™, Zigbee®, LoRa™, Wi-SUN®, or other wireless protocol. While some of the wireless protocols may also be referred to as personal area network (PAN) technology, for simplicity, all are broadly referred to as WLAN technology. Future wireless protocols are also envisioned.

In embodiments, the processor 120 is configured to implement various hardware and logic associated with the first transceiver 103 and the second transceiver 104, and their associated wireless communications protocols. For example, the processor 120 may be configured to implement a medium access control (MAC) layer that is configured to control hardware associated with a wireless transmission medium, such as a Wi-Fi® transmission medium.

In some embodiments, the client wireless device 102 is configured as a 2×2 Wi-Fi® device in which the first transceiver 103 and the second transceiver 104 are each Wi-Fi® transceivers and each have an associated antenna. In other embodiments, the client wireless device 102 is configured as a 1+1 Wi-Fi® device (or to operate in 1+1 mode) in which transmitting is performed over a first antenna such as the TX antenna 110A and receiving is performed over a second antenna such as the RX antenna 110B, which antennas are kept physically separate and measures are taken to reduce interference between the two antennas. Operating in the 1+1 mode, the client wireless device 102 can enjoy a number of advantages, including having no need for RF switches or duplexers to alternate between transmit and receive, enabling true full-duplex operation (transmit and receive at the same time), reducing leakage and self-interference, and improving signal isolation (better dynamic range and cleaner reflections).

In various embodiments, the client wireless device 102 is within communications range of one or more devices or entities. In one example, the client wireless device 102 is within range of the peer wireless device 112, which may be another wireless device. Accordingly, the peer wireless device may also include a transceiver and associated processing logic configured to facilitate wireless communications in accordance with a wireless communications protocol, such as a Wi-Fi® protocol. Thus, the client wireless device 102 may be configured to establish a wireless connection with the peer wireless device 112, and to transmit and receive data packets to and from the peer wireless device 112.

Moreover, the client wireless device 102 is also in range of an entity such as the object 105. In some embodiments, the client wireless device 102 is configured to switch from a communications mode in which it communicates with the peer wireless device 112, and switch to a sensing mode in which the client wireless device 102 performs one or more sensing operations to determine if an entity, such as the object 105 is present and/or determine a distance to the entity for proximity sensing. In embodiments, components of the client wireless device 102, such as first transceiver 103 and the second transceiver 104, are used for such sensing operations to determine if an object is present in an operational environment of client wireless device 102.

Wireless sensing is realized by analyzing radio signals as they propagate through an environment and detecting the variations resulting from an event or activity of interest. As Wi-Fi® becomes more and more available in public and private spaces (not just in the form of smartphones and routers, but also computers, smartwatches, sensors, etc.), the client wireless device 102 can leverage its ubiquity not just for communication but also for sensing.

In some embodiments, the communication interface 106 is directed by the processor 120 to request/receive packets from the other wireless devices or those that reflect off of objects. In embodiments, these are CSI packets that carry the CSI data discussed herein. The communications interface 106 can further process data symbols received by the second transceiver 104 in a way that the processor 120 can perform further processing, including identifying and parsing data packets received within the wireless signals. In various embodiments, the client wireless device 102 intercepts CSI packets transmitted by the anchor wireless device 102, the peer wireless device 112 (and other wireless devices in the environment), and/or the one or more IoT devices (not illustrated) in the normal course of communication.

In such embodiments, the client wireless device 102 retrieves CSI data from the CSI packets of the wireless signals received through the second transceiver 104. The CSI data can be processed to extract fine-grained information about the amplitude and phase changes of Wi-Fi® or wireless signals as they travel through the environment and measure how the signal changes when objects move, thus enabling sensing applications like motion detection and occupancy estimation. In some embodiments, received signal strength indicator (RSSI) data may also be retrieved from wireless signals and is a measure of the power level of a received radio signal. RSSI may be used to indicate the strength of a wireless connection.

In the case of Wi-Fi® sensing (or WLAN sensing), the Wi-Fi® signal characteristics such as the received RSSI and CSI measurements can be exploited to detect and track the obstacles affecting the channel. In embodiments, CSI describes the channel properties of the communication link between a transmitter and a receiver, taking into account the combined effect of scattering, fading, and power decay with distance on the radio signal. Once this information is extracted, signal processing techniques can be employed to determine the features like range, velocity, angle, and the like. These features can then be used to train various models (machine learning (ML) or deep learning models) to identify and classify different applications. The ML and deep learning models can be performed via one or more neural networks (NNs). In some embodiments, the processor 120 can direct the CSI and RSSI data, the ML model(s), and the one or more NNs to be stored in the storage 124 and operate out of the memory 114.

In alternative embodiments, the ML model(s) and the one or more NNs are stored in the cloud server 150, for example, if the models are too large to be stored at the client wireless device 102. In such embodiments, CSI data and RSSI data can be transmitted to the cloud server 150 for updating ML or NN models. Similarly, once these models are trained, the client wireless device 102 can request for inferences employing such ML or NN models.

In various embodiments, the processor 120 can be configured to operate via the front end 101 to perform measurement acquisition, measurement processing, and execute sensing algorithms in relation to obtaining and employing CSI data for environmental sensing. In measurement acquisition, the processor 120 can obtain sensing measurements from 802.11-based communication packets. This has been more challenging, as the current 802.11 standards do not explicitly support sensing. Wi-Fi® sensing applications make use of CSI between the access point (AP) and the station (STA), tracking the CSI over time/space to capture certain regularity that can be used to identify patterns. The sub-7 GHz (especially the 5 and 6 GHz) frequency bands used for next-generation WiFi® offer wide bandwidth for ranging purposes. In the case of 60 GHz (or directional multi-gigabit (DMG) as it is popularly known), the wider channel bandwidth results in higher range and angular resolution. DMG sensing performs Doppler estimation while transmitting the DMG burst frames. This is done after the DMG beamforming training phase is completed between the AP and the STA.

During measurement processing, the processor 120 can obtain the timing and phase offsets from the obtained measurement data are filtered out. Then, different signal processing algorithms can be applied to further process the measurement data in order to obtain application-specific features for sensing algorithms. Once the processor 120 has the processed information from the measurement data, the processor can design or apply algorithms for different applications. While some algorithms are for complex applications and are thus data-driven, for simple detection-based applications, thresholding and signal processing schemes may suffice.

In embodiments, IEEE 802.11bf has defined and categorized a variety of use cases for Wi-Fi® sensing, the most significant ones including room sensing, healthcare, gesture recognition, and in-car sensing. Room sensing applications include human presence and motion detection, people counting and tracking, object and obstacle detection, and intruder detection. Healthcare includes fall and abnormal position detection, heart rate monitoring, breathing rate monitoring, and sneeze sensing. Gesture recognition includes hand and finger gesture recognition, human activity recognition, gesture-based home appliance control. In-car sensing includes detection of humans in the car, driver sleepiness detection, and the like.

For the reasons discussed previously, namely the deficiencies with employing only one frequency band or one mode of sensing, the present disclosure explains how the client wireless device 102 can concurrently employ (e.g., via time-multiplexing) multiple wireless bands, whether in the regular wireless mode (i.e., regular Wi-Fi® mode) or the wireless radar mode (i.e., Wi-Fi® radar mode). Further, the present disclosure describes how the client wireless device 102 can time-multiplex between operating in the regular wireless mode and the wireless radar mode. When switching into radar mode, the client wireless device 102 can transmit wireless signals using the first transceiver 103 (or transmitter) and receive reflected wireless signals (or reflected versions of the transmitted wireless signals) from which to retrieve the CSI data and RSSI data, as will be discussed with reference to FIG. 2.

FIG. 2 is a schematic block diagram of a client wireless device 201 configured to perform radar sensing according to some embodiments. For example, in a system, such as a system 200, may include wireless devices that are used for wireless communications, and are also configured to be able to perform detection, identification, and ranging operations. Accordingly, as will be discussed in greater detail below, a wireless device included in system 200 may be configured to enable seamless interleaving of communications operations and sensing operations. In some embodiments, the client wireless device 201 is the client wireless device 102.

In embodiments, the system 200 includes a wireless device, such as wireless device 201 that is configured to transmit and receive data in accordance with one or more wireless communications protocols. Accordingly, the wireless device 201 may include transmit processing device 202 (or processor) which may provide digital data to be transmitted. Such data may be received from other components of wireless device 201, such as a host processor or other processing device configured to generate a data stream in accordance with a wireless communications protocol, such as a Wi-Fi® protocol. In various embodiments, such data may be received from components external to wireless device 201. For example, a host processor may be implemented in a different device or on a different chip, and data may be received via a communications interface. An output of transmit processing device 202 may be provided to digital-to-analog converter (DAC) 203, and then to low pass filter (LPF) 204 and power amplifier (PA) 208 via mixer 206 for transmission via transmit-receive (T/R) switch 218 and antenna 220. In some embodiments, DAC 203, LPF 204, mixer 206, and PA 208 are part of a transmit chain included in a first transceiver 103. In various embodiments, the first transceiver 103 may also include a receive chain that includes low noise amplifier (LNA) 210, mixer 212, amplifier 214 and analog-to-digital converter (ADC) 216.

The wireless device 201 may also include one or more components for receiving signals. For example, a signal may be received via antenna 242, provided to LNA 232, then provided to mixer 234, amplifier 236, and then analog to digital converter (ADC) 238. ADC 238 may then provide the received signal to other components of a second transceiver 104, such as receive processing device 222. In some embodiments, LNA 232, mixer 239, mixer 234, amplifier 236, and ADC 238 are part of a receive chain included in the second transceiver. In various embodiments, the second transceiver 104 may also include a transmit chain that includes DAC 224, LPF 226, mixer 228, and PA 230. The transmit chain may be coupled to antenna 242 via switch 240.

In various embodiments, the wireless device 201 further includes signal generator 250 which is configured to generate a signal that is provided to may be provided to mixer 212, mixer 206, mixer 234, and mixer 228. Signal generator 250 may include various components such as a phase locked loop (PLL) circuit that may be coupled to a frequency divider. As shown in FIG. 2, a communications path may also be provided between mixer 206 and mixer 234. Accordingly, signal generator 250 may be configured to generate a designated waveform that is transmitted, and may also be configured to generate a reference waveform for a received signal. In some embodiments, signal generator 250 includes a voltage controlled oscillator (VCO) that is configured to generate a carrier frequency to convert a high frequency signal to a baseband signal.

As similarly discussed above, the wireless device 201 is configured to perform wireless communication operations in accordance with a wireless communications protocol such as a Wi-Fi® protocol. In some embodiments, the first transceiver 103 and second transceiver 104 included in the wireless device 201 are configured to switch to a sensing configuration that supports sensing operations. Moreover, when such switching is performed, the switching may be implemented without disconnecting from a communications link used in the communications mode. In some embodiments, a channel used for the communications link may be used for the sensing operations as well. When configured in this way, the wireless device 201 may transmit a signal via a transmit chain of the first transceiver 103, and an entity may reflect the signal back to wireless device 201 which may be received at a receive chain of the second transceiver 104. In this way, the first transceiver 103 may be configured to transmit a signal, and the second transceiver 104 may be configured to receive a signal reflected by the entity. Moreover, a reference signal may also be generated and captured, and a transit time may also be determined. In other embodiments, timestamp at transmitter may be used to determine a transit time.

In at least some embodiments, the wireless device 201 includes one or more components, such as signal processing device 244 (or processor), configured to extract data values from the received signal, or perform one or more sensing operations, such as presence detection and ranging. In some embodiments, the wireless device 201 is configured to determine whether or not an entity, such as an object, is present based on the extracted sensing values. Moreover, wireless device 201 may be configured to store the extracted data values and/or may be configured to transmit the extracted sensing values to another device that may be configured to determine whether or not the entity is present. In this way, processing operations associated with detection of the entity may be offloaded from wireless device 201, and extracted sensing data may be transmitted once the transceivers have been switched back to a communications mode. As discussed above, the wireless device 201 may still be connected to the communications link. Accordingly, when switched back to the communications mode, the wireless device 201 may continue using the previously established communications link.

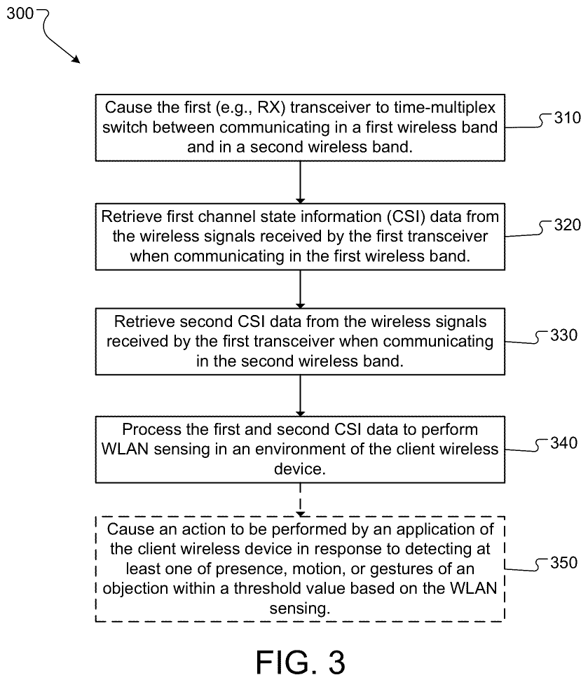

FIG. 3 is a flow chart of a method 300 for performing concurrent multi-band sensing by the client wireless device 102 in a regular wireless mode, such as in a regular Wi-Fi® mode, according to some embodiments. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. For example, the method 300 may be performed by the processor 120 (FIG. 1) or processing devices 202, 222, and/or 244 (FIG. 2).

While the operations of the method 300 are listed and numerically sequenced, the method 300 may be performed without one or more operations or may include other operations, some of which may be discussed elsewhere within this disclosure. For example, dashed boxes indicate optional operations. Further, one or more operations may be performed in a different sequence. Thus, description of the method 300 can be understood in the larger context of this entire disclosure without limitation to particular ordering.

At operation 310, the processing logic causes the first transceiver 103 to time-multiplex switch between communicating in a first wireless band and in a second wireless band. In one embodiment, the first wireless band is the 2.4 GHz band and the second wireless band is the 5.0 GHz band. In at least a second embodiment, the first wireless band is the 2.4 GHz band and the second wireless band is the 6.0 GHz band. In at least a third embodiment, the first wireless band is the 5.0 GHz band and the second wireless band is the 6.0 GHz band.

At operation 320, the processing logic retrieves first channel state information (CSI) data from the wireless signals received by the first transceiver 103 when communicating in the first wireless band.

At operation 330, the processing logic retrieves second CSI data from the wireless signals received by the first transceiver when communicating in the second wireless band.

At operation 340, the processing logic processes the first and second CSI data to perform WLAN sensing in an environment of the client wireless device.

At optional operation 350, the processing logic causes an action to be performed by an application of the client wireless device in response to detecting at least one of presence, motion, or gestures of an object within a threshold value based on the WLAN sensing.

With additional reference to FIG. 1, in some embodiments, the WLAN sensing is IEEE 802.11bf-capable sensing or is supported by another future standard with enhanced sensing, and the processing logic is further to receive, via the first transceiver 103, additional CSI data retrieved, from the wireless signals, by a second wireless device in a vicinity of the client wireless device. The second wireless device may be the peer wireless device 112. The processing logic can further process a combination of the first and second CSI data and the additional CSI data to perform the WLAN sensing. In at least some embodiments, the processing logic retrieves RSSI data received in the wireless signals by the first transceiver 103 over the first wireless band and over the second wireless band and processes a combination of the RSSI data and the first and second CSI data to perform the WLAN sensing.

Further, assuming that some wireless peer devices and/or an anchor wireless device in the environment of the client wireless device are communicating in the different wireless bands, the processing logic can further cause the first transceiver 103, when receiving in the first wireless band, to scan within sub-band ranges of the first wireless band over different time periods while operating at a first phase. The processing logic can accumulate the first CSI data across scanning within the sub-band ranges of the first wireless band. The processing logic can further cause the first transceiver 103, when receiving in the second wireless band, to scan within sub-band ranges of the second wireless band over different time periods while operating in a second phase. The processing logic can cumulate the second CSI data across the scanning within the sub-band ranges of the second wireless band. For example, ˜20 megahertz (MHz) sub-bands may span within the 2.4 GHz band and ˜1 GHz sub-bands may span within the 5.0 and 6.0 GHz bands. In this way, by scanning across the wireless bands within sub-band ranges (or channels), the effective bandwidth of detected wireless signals and resultant CSI data can be increased.

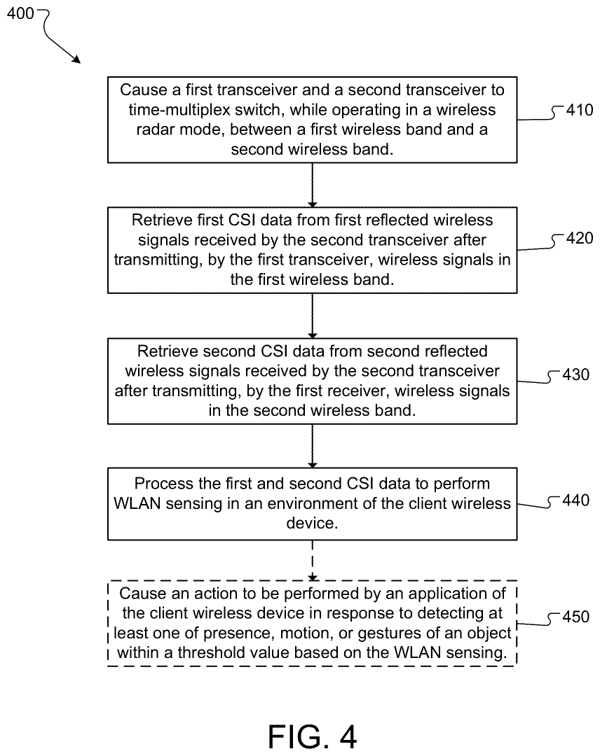

FIG. 4 is a flow chart of a method 400 for performing concurrent multi-band sensing by the client wireless device in a wireless radar mode, such as the Wi-Fi® radar mode, according to some embodiments. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. For example, the method 400 may be performed by the processor 120 (FIG. 1) and/or processing devices 202, 222, and/or 244 (FIG. 2).

While the operations of the method 400 are listed and numerically sequenced, the method 400 may be performed without one or more operations or may include other operations, some of which may be discussed elsewhere within this disclosure. For example, dashed boxes indicate optional operations. Further, one or more operations may be performed in a different sequence. Thus, description of the method 400 can be understood in the larger context of this entire disclosure without limitation to particular ordering.

At operation 410, the processing logic causes a first transceiver and a second transceiver to time-multiplex switch, while operating in a Wi-Fi® radar mode, between a first wireless band and a second wireless band. In some embodiments, operating in the Wi-Fi® radar mode is performed without dependency on operation of the anchor wireless device 112 such as an AP device. In one embodiment, the first wireless band is the 2.4 GHz band and the second wireless band is the 5.0 GHz band. In at least a second embodiment, the first wireless band is the 2.4 GHz band and the second wireless band is the 6.0 GHz band. In at least a third embodiment, the first wireless band is the 5.0 GHz band and the second wireless band is the 6.0 GHz band.

At operation 420, the processing logic retrieves first CSI data from first reflected wireless signals received by the second transceiver 104 after transmitting, by the first transceiver 103, wireless signals in the first wireless band. For example, the processing logic may cause the first transceiver to transmit first wireless signals in the first wireless band for a first time period and later cause the second transceiver to receive the first reflected wireless signals during the first time period.

At operation 430, the processing logic retrieves second CSI data from second reflected wireless signals received by the second transceiver after transmitting, by the first receiver, wireless signals in the second wireless band. For example, the processing logic may cause the first transceiver to transmit second wireless signals in the second wireless band for a second time period after the first time period and later cause the second transceiver to receive the second reflected wireless signals during the second time period.

At operation 440, the processing logic processes the first and second CSI data to perform WLAN sensing in an environment of the client wireless device.

At optional operation 450, the processing logic causes an action to be performed by an application of the client wireless device in response to detecting at least one of presence, motion, or gestures of an object within a threshold value based on the WLAN sensing.

With additional reference to FIG. 1, in some embodiments, assuming that some wireless peer devices and/or an anchor wireless device in the environment of the client wireless device are communicating in the different wireless bands, the processing logic can further cause the first and second transceivers to scan within first sub-band ranges of the first wireless band over different time periods while operating at a first phase. The processing logic can cumulate the first CSI data across the scanning within the first sub-band ranges of the first wireless band to increase a bandwidth of the WLAN scanning. The processing logic can further cause the first and second transceivers to scan within second sub-band ranges of the second wireless band over different time periods while operating at a second phase. The processing logic can further cumulate the second CSI data across the scanning within the second sub-band ranges of the second wireless band to increase the bandwidth of the WLAN scanning. For example, ˜20 MHz sub-bands may span within the 2.4 GHz band and ˜1 GHz sub-bands may span within the 5.0 and 6.0 GHz bands. In this way, by scanning across the wireless bands within sub-band ranges (or channels), the effective bandwidth of detected wireless signals and resultant CSI data can be increased.

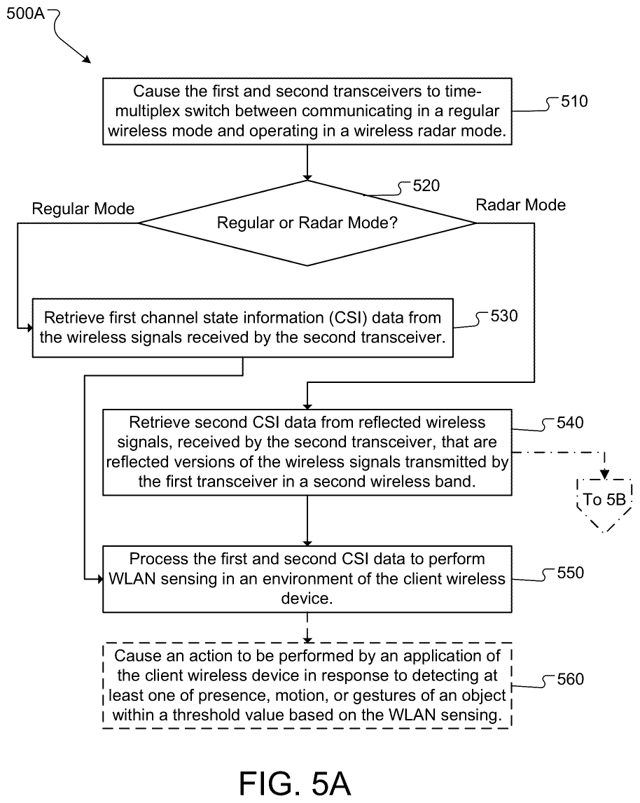

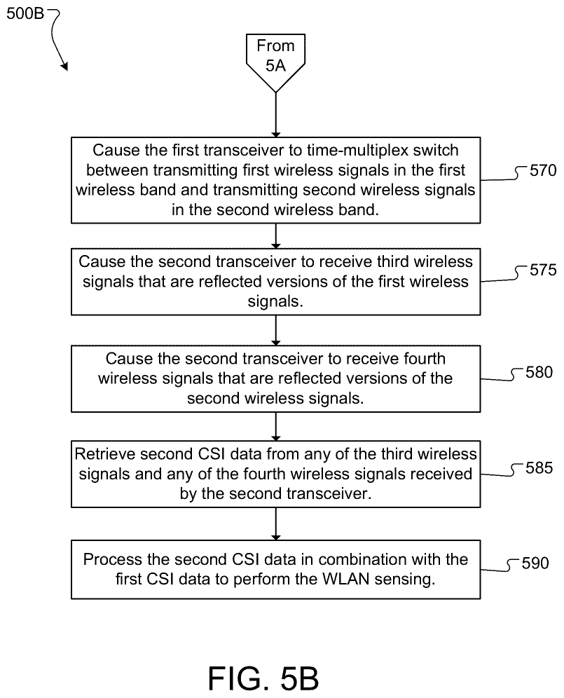

FIG. 5A is a flow chart of a method 500A for performing concurrent multi-band and multi-mode sensing that employs both regular wireless mode and wireless radar mode according to some embodiments. The method 500A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. For example, the method 500A may be performed by the processor 120 (FIG. 1) and/or processing devices 202, 222, and/or 244 (FIG. 2).

While the operations of the method 500A are listed and numerically sequenced, the method 500A may be performed without one or more operations or may include other operations, some of which may be discussed elsewhere within this disclosure. For example, dashed boxes indicate optional operations. Further, one or more operations may be performed in a different sequence. Thus, description of the method 500A can be understood in the larger context of this entire disclosure without limitation to particular ordering.

At operation 510, the processing logic causes the first transceiver 103 and the second transceiver 104 to time-multiplex switch between communicating in a regular wireless mode and operating in a wireless radar mode. In embodiments, operating in the regular wireless mode is in the regular Wi-Fi® mode, operating in the wireless radar mode is in the Wi-Fi® radar mode, and the Wi-Fi® radar mode is performed without dependency on operation of an anchor wireless device such as an AP device.

At operation 520, the processing logic detects in which mode the client wireless device is operating, whether in the regular wireless mode or in the wireless radar mode.

At operation 530, when communicating in the regular wireless mode in a first wireless band, the processing logic retrieves first CSI data from the wireless signals received by the second transceiver 104.

At operation 540, when operating in the wireless radar mode, the processing logic retrieves second CSI data from reflected wireless signals received by the second transceiver 104. In embodiments, the reflected wireless signals are reflected versions of the wireless signals transmitted by the first transceiver 103 in a second wireless band. In at least some embodiments, operation 540 may be further implemented as described with reference to FIG. 5B.

In embodiments associated with operation 540, operating in the Wi-Fi® radar mode can be performed without dependency on operation of an access point device. In one embodiment, the first wireless band is a 2.4 GHz band and the second wireless band is a 5.0 or 6.0 GHz band. In a second embodiment, the first wireless band is the 5.0 or 6.0 GHz band and the second wireless band is the 2.4 GHz band. In a third embodiment, the first wireless band is the 5.0 GHz band and the second wireless band is the 6.0 GHz band. In a fourth embodiment, the first wireless band is the 6.0 GHz band and the second wireless band is the 5.0 GHz band.

At operation 550, the processing logic processes the first and second CSI data to perform WLAN sensing in an environment of the client wireless device.

At optional operation 560, the processing logic causes an action to be performed by an application of the client wireless device in response to detecting at least one of presence, motion, or gestures of an object within a threshold value based on the WLAN sensing.

With additional reference to FIGS. 1-2, the processing logic can switch ones of the first wireless band and the second wireless band to employ different combinations of frequency bands between communicating in the regular wireless mode and operating in the wireless radar mode. In such embodiments, the processing logic selects, by inputting the first and second CSI data into a trained machine learning model, a particular combination of the first wireless band and the second wireless band that results in a most-accurate sensing performance.

In some embodiments, when operating in the wireless radar mode, the processing logic causes the first and second transceivers to scan within sub-band ranges of the second wireless band over different time periods while operating at a first phase. The processing logic further cumulates the second CSI data across the scanning within the sub-band ranges of the second wireless band to increase a bandwidth of the WLAN scanning.

In some embodiments, the WLAN sensing is IEEE 802.11bf-capable sensing. In such embodiments, the processing logic receives, via the first transceiver 103, additional CSI data retrieved, from the wireless signals, by a second wireless device in a vicinity of the client wireless device. The processing logic can further process a combination of the first and second CSI data and the additional CSI data to perform the WLAN sensing.

FIG. 5B is a flow chart of a method 500B for performing the radar sensing in the Wi-Fi® radar mode also in multiple bands according to some embodiments. The method 500B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. For example, the method 500B may be performed by the processor 120 (FIG. 1) and/or processing devices 202, 222, and/or 244 (FIG. 2).

While the operations of the method 500B are listed and numerically sequenced, the method 500B may be performed without one or more operations or may include other operations, some of which may be discussed elsewhere within this disclosure. For example, dashed boxes indicate optional operations. Further, one or more operations may be performed in a different sequence. Thus, description of the method 500B can be understood in the larger context of this entire disclosure without limitation to particular ordering.

At operation 570, the processing logic causes the first transceiver 103 to time-multiplex switch between transmitting first wireless signals in the first wireless band and transmitting second wireless signals in the second wireless band.

At operation 575, the processing logic cause the second transceiver 104 to receive third wireless signals that are reflected versions of the first wireless signals.

At operation 580, the processing logic causes the second transceiver 104 to receive fourth wireless signals that are reflected versions of the second wireless signals.

At operation 585, the processing logic retrieves third CSI data from any of the third wireless signals and any of the fourth wireless signals received by the second transceiver.

At operation 590, the processing logic processes the third CSI data in combination with the first and second CSI data to perform the WLAN sensing.

It will be apparent to one skilled in the art that at least some embodiments may be practiced without these specific details. In other instances, well-known components, elements, or methods are not described in detail or are presented in a simple block diagram format in order to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non-transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like), so that when executed by the processor(s) or the equivalents thereof, the instructions cause the device(s) to perform the described operations for USB-C/PD mode-transition architecture described herein. The non-transitory computer-readable storage medium may include, but is not limited to, electromagnetic storage medium, read-only memory (ROM), random-access memory (RAM), erasable programmable memory (e.g., EPROM and EEPROM), flash memory, or another now-known or later-developed non-transitory type of medium that is suitable for storing information.

Although the operations of the circuit(s) and block(s) herein are shown and described in a particular order, in some embodiments the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A client wireless device comprising:
a first transceiver to receive wireless signals over a first antenna;
a processor coupled to the first transceiver; and
memory storing instructions that, when executed by the processor, cause the processor to:
cause the first transceiver to time-multiplex switch between communicating in a first wireless band and in a second wireless band;
retrieve first channel state information (CSI) data from the wireless signals received by the first transceiver when communicating in the first wireless band;
retrieve second CSI data from the wireless signals received by the first transceiver when communicating in the second wireless band; and
process the first and second CSI data to perform wireless local area network (WLAN) sensing in an environment of the client wireless device.

2. The client wireless device of claim 1, wherein the instructions further cause the processor to cause an action to be performed by an application of the client wireless device in response to detecting at least one of presence, motion, or gestures of an object within a threshold value based on the WLAN sensing.

3. The client wireless device of claim 1, wherein one of:
the first wireless band is a 2.4 gigahertz (GHz) band and the second wireless band is a 5.0 GHz band;
the first wireless band is the 2.4 GHz band and the second wireless band is a 6.0 GHz band; or
the first wireless band is the 5.0 GHz band and the second wireless band is the 6.0 GHz band.

4. The client wireless device of claim 1, wherein the WLAN sensing is IEEE 802.11bf-capable sensing, and the instructions further cause the processor to:
receive, via the first transceiver, additional CSI data retrieved, from the wireless signals, by a second wireless device in a vicinity of the client wireless device; and
process a combination of the first and second CSI data and the additional CSI data to perform the WLAN sensing.

5. The client wireless device of claim 1, wherein the instructions further cause the processor to:
retrieve received signal strength indicator (RSSI) data received in the wireless signals by the first transceiver over the first wireless band and over the second wireless band; and
process a combination of the RSSI data and the first and second CSI data to perform the WLAN sensing.

6. The client wireless device of claim 1, further comprising a second transceiver, coupled to the processor, to transmit wireless signals over a second antenna, wherein the instructions further cause the processor to:
cause the second transceiver and the first transceiver to time-multiplex switch between communicating in a regular Wi-Fi® mode and operating in a Wi-Fi® radar mode;
when operating in the Wi-Fi® radar mode:
cause the second transceiver to time-multiplex switch between transmitting first wireless signals in the first wireless band and transmitting second wireless signals in the second wireless band;
cause the first transceiver to receive third wireless signals that are reflected versions of the first wireless signals; and
cause the first transceiver to receive fourth wireless signals that are reflected versions of the second wireless signals;
retrieve third CSI data from any of the third wireless signals and any of the fourth wireless signals received by the first transceiver; and
process the third CSI data in combination with the first and second CSI data to perform the WLAN sensing.

7. The client wireless device of claim 6, wherein operating in the Wi-Fi® radar mode is performed without dependency on operation of an anchor wireless device.

8. The client wireless device of claim 1, wherein the instructions further cause the processor to:
cause the first transceiver, when receiving in the first wireless band, to scan within sub-band ranges of the first wireless band over different time periods while operating at a first phase;
cumulate the first CSI data across the scanning within the sub-band ranges of the first wireless band;
cause the first transceiver, when receiving in the second wireless band, to scan within sub-band ranges of the second wireless band over different time periods while operating at a second phase; and
cumulate the second CSI data across the scanning within the sub-band ranges of the second wireless band.

9. A method comprising:
causing, by a processor of a client wireless device, a first transceiver and a second transceiver to time-multiplex switch, while operating in a wireless radar mode, between a first wireless band and a second wireless band;
retrieving first channel state information (CSI) data from first reflected wireless signals received by the second transceiver after transmitting, by the first transceiver, wireless signals in the first wireless band;
retrieving second CSI data from second reflected wireless signals received by the second transceiver after transmitting, by the first receiver, wireless signals in the second wireless band; and
processing, by the processor, the first and second CSI data to perform wireless local area network (WLAN) sensing in an environment of the client wireless device.

10. The method of claim 9, further comprising causing an action to be performed by an application of the client wireless device in response to detecting at least one of presence, motion, or gestures of an object within a threshold value based on the WLAN sensing.

11. The method of claim 9, wherein the wireless radar mode cause the client wireless device to operates in a Wi-Fi® radar mode without dependency on operation of an anchor wireless device.

12. The method of claim 9, further comprising:
causing the first transceiver to transmit first wireless signals in the first wireless band for a first time period;
causing the second transceiver to receive the first reflected wireless signals during the first time period;
causing the first transceiver to transmit second wireless signals in the second wireless band for a second time period after the first time period; and
causing the second transceiver to receive the second reflected wireless signals during the second time period.

13. The method of claim 9, wherein at least one of:
the first wireless band is a 2.4 gigahertz (GHz) band and the second wireless band is a 5.0 GHz band;
the first wireless band is the 2.4 GHz band and the second wireless band is a 6.0 GHz band; or
the first wireless band is the 5.0 GHz band and the second wireless band is the 6.0 GHz band.

14. The method of claim 9, further comprising:
causing the first and second transceivers to scan within first sub-band ranges of the first wireless band over different time periods while operating at a first phase;
cumulating the first CSI data across the scanning within the first sub-band ranges of the first wireless band to increase a bandwidth of the WLAN scanning;
causing the first and second transceivers to scan within second sub-band ranges of the second wireless band over different time periods while operating at a second phase; and
cumulating the second CSI data across the scanning within the second sub-band ranges of the second wireless band to increase the bandwidth of the WLAN scanning.

15. A client wireless device comprising:
a first transceiver to transmit wireless signals over a first antenna;
a second transceiver to receive wireless signals over a second antenna;
a processor coupled to the first transceiver and the second transceiver; and
memory storing instructions that, when executed by the processor, cause the processor to:
cause the first transceiver and the second transceiver to time-multiplex switch between communicating in a regular wireless mode and operating in a wireless radar mode;
when communicating in the regular wireless mode in a first wireless band, retrieve first channel state information (CSI) data from the wireless signals received by the second transceiver;
when operating in the wireless radar mode, retrieve second CSI data from reflected wireless signals received by the second transceiver, wherein the reflected wireless signals are reflected versions of the wireless signals transmitted by the first transceiver in a second wireless band; and
process the first and second CSI data to perform wireless local area network (WLAN) sensing in an environment of the client wireless device.

16. The client wireless device of claim 15, wherein the instructions are further to cause an action to be performed by an application of the client wireless device in response to detecting at least one of presence, motion, or gestures of an object within a threshold value based on the WLAN sensing.

17. The client wireless device of claim 15, wherein operating in the regular wireless mode is in a regular Wi-Fi® mode, operating in the wireless radar mode is in a Wi-Fi® radar mode, and the Wi-Fi® radar mode is performed without dependency on operation of an anchor wireless device.

18. The client wireless device of claim 15, wherein the instructions further cause the processor to:
switch ones of the first wireless band and the second wireless band to employ different combinations of frequency bands between communicating in the regular wireless mode and operating in the wireless radar mode; and
select, by inputting the first and second CSI data into a trained machine learning model, a particular combination of the first wireless band and the second wireless band that results in a most-accurate sensing performance.

19. The client wireless device of claim 15, wherein at least one of:
the first wireless band is a 2.4 GHz band and the second wireless band is a 5.0 or 6.0 GHz band;
the first wireless band is the 5.0 or 6.0 GHz band and the second wireless band is the 2.4 GHz band;
the first wireless band is the 5.0 GHz band and the second wireless band is the 6.0 GHz band; or
the first wireless band is the 6.0 GHz band and the second wireless band is the 5.0 GHz band.

20. The client wireless device of claim 15, wherein the instructions further cause the processor to:
when operating in the wireless radar mode, cause the first and second transceivers to scan within sub-band ranges of the second wireless band over different time periods while operating at a first phase; and
cumulate the second CSI data across the scanning within the sub-band ranges of the second wireless band to increase a bandwidth of the WLAN scanning.

21. The client wireless device of claim 15, wherein the WLAN sensing is IEEE 802.11bf-capable sensing, and the instructions further cause the processor to:
receive, via the first transceiver, additional CSI data retrieved, from the wireless signals, by a second wireless device in a vicinity of the client wireless device; and
process a combination of the first and second CSI data and the additional CSI data to perform the WLAN sensing.
